(19) United States
(12) Patent Application Publication
(10) Pub. No.: US 2009/0056075 A1
(43) Pub. Date: Mar. 5, 2009

(54) Hinge With Locking Tab

(75) Inventors: John M. Green, East Otto, NY (US); Michael Manis, Kennedy, NY (US)

Correspondence Address: THE WEBB LAW FIRM, P.C., 700 KOPPERS BUILDING, 436 SEVENTH AVENUE, PITTSBURGH, PA, 15219, US

(73) Assignee: Bush Industries, Inc., Jamestown, NY (US)

(21) Appl. No.: 12/201,269

(22) Filed: Aug. 29, 2008

Related U.S. Application Data
(60) Provisional application No. 60/966,957, filed on Aug. 31, 2007.

(51) Int. Cl. E05D 11/10

(52) U.S. Cl. 16/328

(57) ABSTRACT

The invention is directed to a hinge with a locking tab made up of a first hinge part having a post extending therefrom and a second hinge part having a sleeve mateable with the post, wherein the sleeve is placed over the post to assemble the hinge. Furthermore, a resilient locking tab associated with one of the first hinge part and the second hinge part is positioned to resiliently snap over the other of the first hinge part or the second hinge part when the parts are fully engaged.

### CROSS REFERENCE TO RELATED APPLICATIONS

This application claims the benefit of U.S. Provisional Application No. 60/966,957, filed Aug. 31, 2007.

### BACKGROUND OF THE INVENTION

1. Field of the Invention

The invention relates to a hinge and, more particularly, to a two-part hinge, wherein the two parts are axially secured to one another through a locking tab.

2. Description of Related Art

The assembly of hinges to support two adjacent members may require inserting a hinge pin between two hinge parts. Alignment and securing such a hinge pin may be challenging. In the alternative, another type of hinge is comprised of a protruding post on a first mounting plate and a mating sleeve on a second mounting plate. The mounting sleeve is placed over the post to hang the hinge. However, the sleeve may be easily lifted from the post at any time.

A hinge design is needed, wherein not only may the hinge parts be quickly assembled, but furthermore, once assembled, the hinge parts should be locked in place.

### SUMMARY OF THE INVENTION

One embodiment of the subject invention is directed to a lockable connector having a first hinge part having a sleeve with a bore extending along a longitudinal axis and a second hinge part having a post support with a post extending therefrom. The post extends along the longitudinal axis and is slidingly positioned within the bore of the sleeve. The sleeve abuts with the post support and a resilient locking tab is positioned to secure the hinge parts with respect to one another along the longitudinal axis.

Another embodiment of the subject invention is directed to a locking device for use with a first hinge part having a sleeve with a bore extending along a longitudinal axis and a second hinge part having a post support with a post extending therefrom. The post extends along the longitudinal axis and is slidingly positioned within the bore of the sleeve and the sleeve abuts with the post support. The locking device comprises a support plate with a generally planar base and a resilient tab extending from the base in an out-of-plane orientation. The plate is adapted to be positioned such that the tab interferes with the axial motion of the first hinge part relative to the second hinge part to secure the first hinge part to the second hinge part.

Yet another embodiment of the subject invention is directed to a furniture piece having a first member generally lying in a first member plane and a second member generally lying in a second member plane. The first hinge part is attached to the first member and the second hinge part is attached to the second member through a lockable connector. The lockable connector has a first hinge part having a sleeve with a bore extending along a longitudinal axis and a second hinge part having a post support with a post extending therefrom along the longitudinal axis. The second hinge is slidingly positioned within the bore of the sleeve and the sleeve abuts with the post support. A resilient locking tab is positioned to secure the hinge parts with respect to one another along the longitudinal axis.

### BRIEF DESCRIPTION OF THE DRAWINGS

FIG. 1 illustrates a perspective view of the assembled hinge in accordance with the subject invention;

FIG. 2 illustrates a perspective view of the first hinge part and the support plate;

FIG. 3 illustrates a perspective view of the support plate secured to the first hinge part;

FIG. 4 illustrates a perspective view of the second hinge part;

FIGS. 5-7 illustrate the sequence to secure the hinge parts together;

FIG. 8 illustrates another embodiment of the subject invention, wherein the locking tab is secured to the second hinge part;

FIG. 9A is a perspective view of the support plate; and

FIGS. 9B, 9C, and 9D are a front, side, and top view, respectively, of the support plate.

### DESCRIPTION OF THE INVENTION

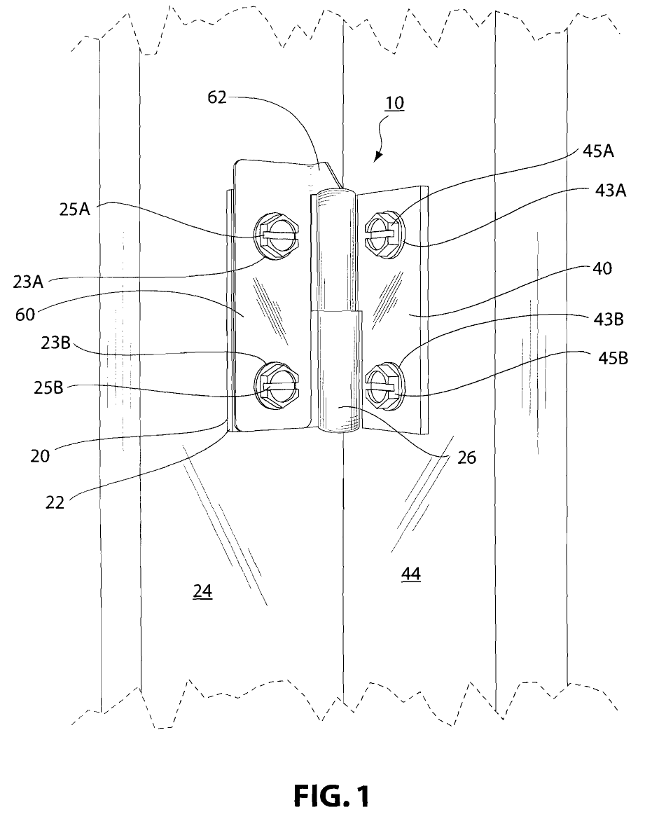

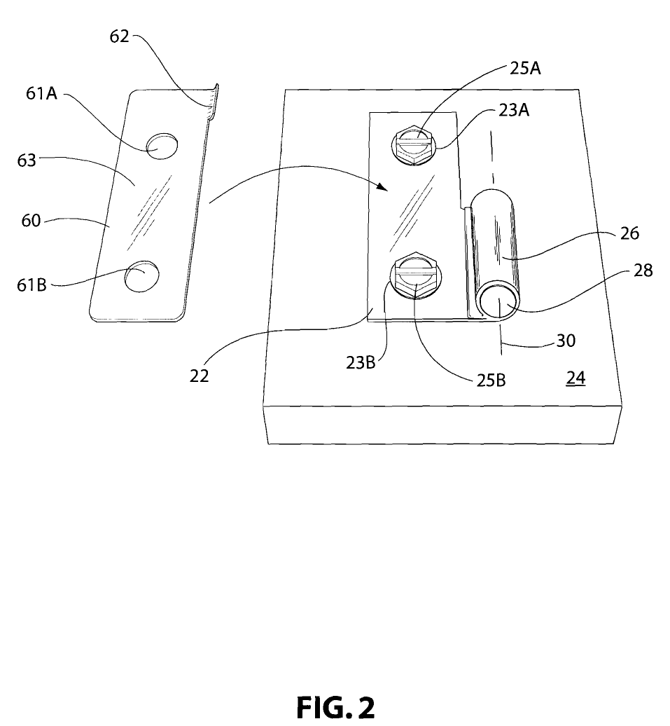

FIG. 1 illustrates a perspective view of a hinge 10, while FIGS. 2-4 illustrate component parts of the hinge 10. FIGS. 1-4 will be discussed together.

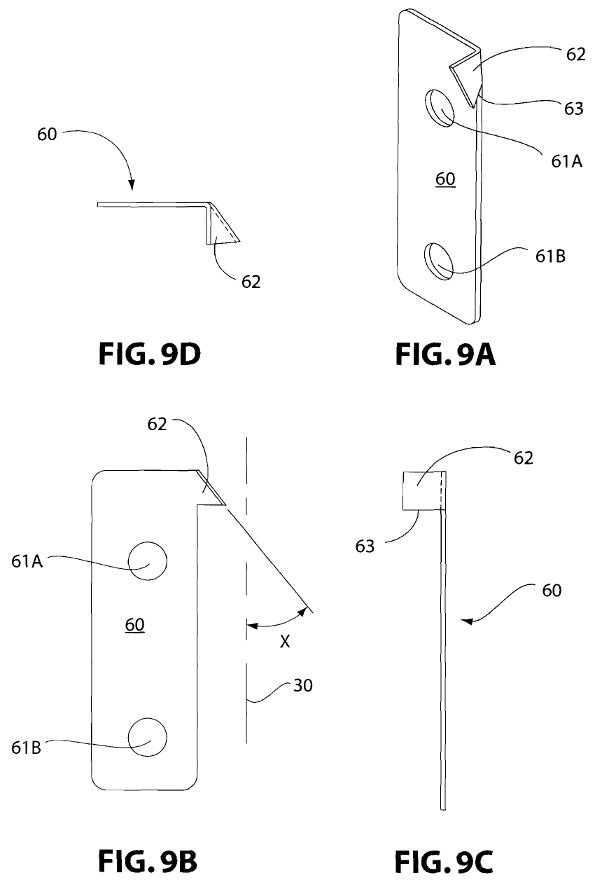

The hinge 10 is comprised of a first hinge part 20 and a second hinge part 40. The first hinge part 20 has a first mounting plate 22 (FIG. 2) secured to a first member 24 using fasteners 25A, 25B extending through first hinge part apertures 23A, 23B. A sleeve 26 having a bore 28 extending therethrough and along a longitudinal axis 30 extends from the first mounting plate 22. Secured over the first mounting plate 22 is a support plate 60 having a resilient locking tab 62 extending therefrom. The support plate 60 is secured to the first mounting plate 22 with the fasteners 25A, 25B extending through support plate apertures 61A, 61B (FIG. 9A), which align with the first hinge part apertures 23A, 23B.

The support plate 60 has a generally planar base 63 and the resilient tab 62 extends from the base 63 in an out-of-plane orientation, such that the tab 62 interferes with the axial motion of the first hinge part 20 relative to the second hinge part 40 to secure the first hinge part 20 to the second hinge part 40.

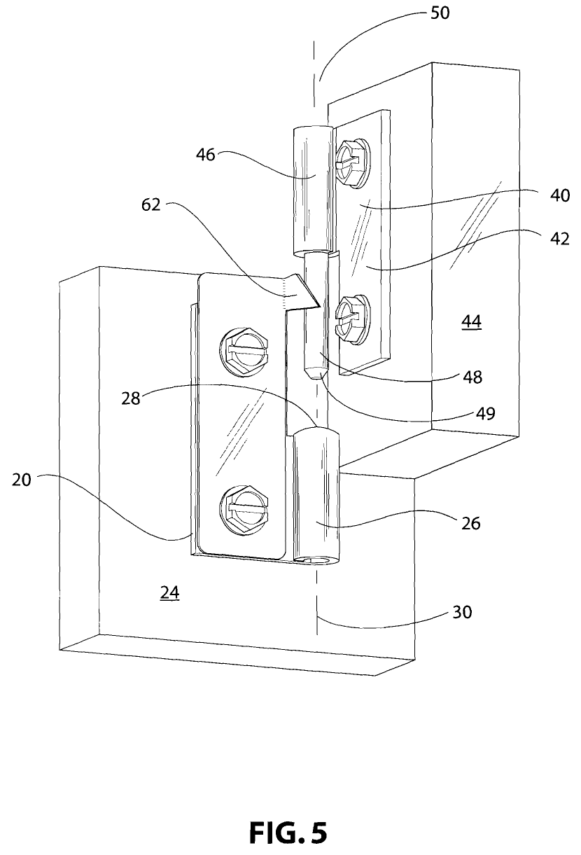

The second hinge part 40 is comprised of a post support 46 and a post 48 extending therefrom. The post 48 extends along a longitudinal axis 50, and is slidingly positioned within the bore 28 (FIG. 5). The bore 28 of the sleeve 26 is sized to accept the post 48. When the post 48 is inserted within the bore 28, the sleeve 26 abuts with the post support 46. While it is possible for the circular post 48 to rotate within the bore 28 of the sleeve 26, such that the hinge parts 20, 40 pivot about the post 48 relative to one another, in one embodiment of the subject invention, the hinge 10 may be used solely to support a first member 24 relative to a second member 42 and, under those circumstances, it is not necessary for the shape of the bore 28 and the shape of the post 22 to provide rotation between the first hinge part 20 and the second hinge part 40. Therefore, under these circumstances, the hinge parts 20, 40 may be non-pivotal about the post 48 relative to one another.

The second hinge part 40 is comprised of a second mounting plate 42 secured to a second member 44 with fasteners 45A, 45B extending through second hinge part apertures 43A, 43B.

While illustrated only as small segments, the first member 24 and the second member 44 may represent walls or other panels on a piece of furniture.

As illustrated in FIG. 2, the support plate 60 with the locking tab 62 may be a separate part from the first mounting plate 22. However, it is entirely possible for the first mounting plate 22 to have extending therefrom a resilient locking tab (not shown), thereby eliminating the need for the support plate 60 and associated locking tab 62 as a separate part. As illustrated in FIG. 2, the support plate 60 and the first mounting plate 22 are distinct parts.

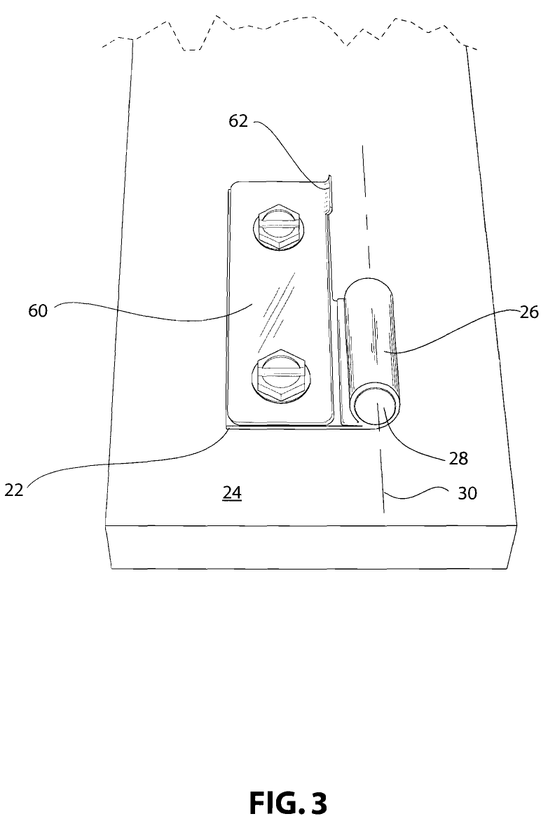

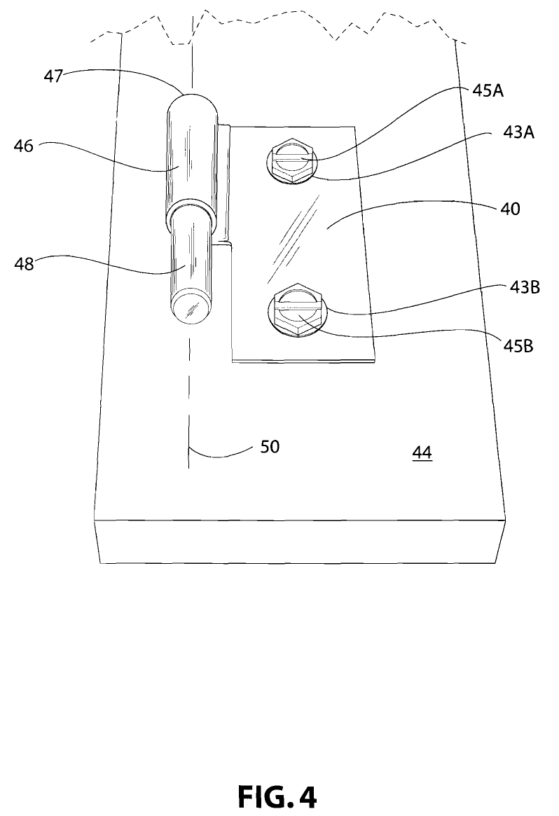

Directing attention to FIGS. 3 and 4, it is important that the locking tab 62 extends over the top 47 of the post support 46 when the second hinge part 40 is engaged with the first hinge part 20 (FIG. 1). In particular and as illustrated in FIGS. 5-7, the locking tab 62 is purposely designed to interfere with the path of the post support 46. In particular, the bore 28 of the sleeve 26 has a longitudinal axis 30 extending therefrom and the post 48 of the post support 46 has a longitudinal axis 50. The longitudinal axis 30 of the bore 28 must be co-axial with the longitudinal axis 50 of the post 48 for the post 48 to fit within the bore 28. The tab 62 interferes with the travel of the post support 46 as the post 48 is positioned within the bore. Directing attention to FIG. 9B, the locking tab 62 is canted by an angle X with respect to the longitudinal axis 30 of the bore 28. As a result, when the post 48 enters the bore 28, the post support 46 contacts and pushes away the resilient locking tab 62 until such time as the locking tab 62 clears the post support 46. The angle X may be between 5 degrees and 45 degrees.

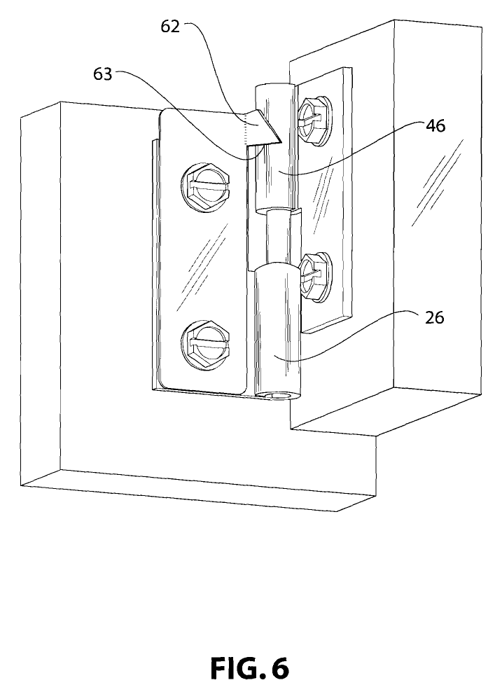

It should also be noted that the profile of the locking tab 62, as illustrated in FIGS. 9A, 9B, 9C, is canted such that the edge 63 is urged away from the post support 46 (FIG. 6) when the second hinge part 40 is placed within the first hinge part 20.

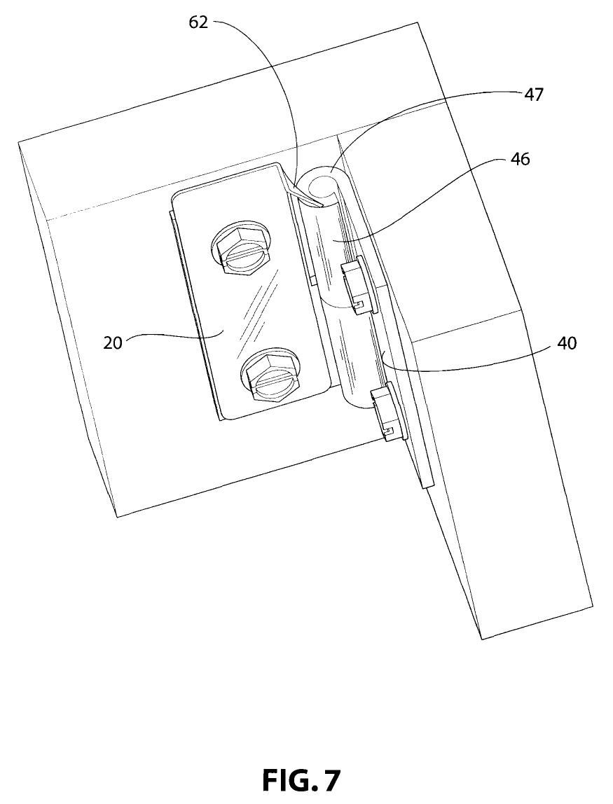

At this point, as illustrated in FIG. 7, the locking tab 62 returns to its original position and extends over a portion of the top 47 of the post support 46, thereby locking the first hinge part 20 together with the second hinge part 40. If necessary, the locking tab 62 can be pushed back to clear the post support 46 so that the second hinge part 40 may be removed from the first hinge part 20.

It is also possible, although not illustrated, for the tab 62 to be an integral part of the first hinge part 20, thereby eliminating the need for the support plate 60. Such an arrangement would be readily envisioned in light of the present disclosure by one of ordinary skill in the art.

FIG. 5 illustrates a post 48 prior to insertion into the bore 28. In order to make insertion of the post 48 into the bore 28 of the sleeve 26 easier, the post 48 has a beveled surface 49. The top 28 of the sleeve 26 may also have a beveled portion (not shown) to accept the post 48.

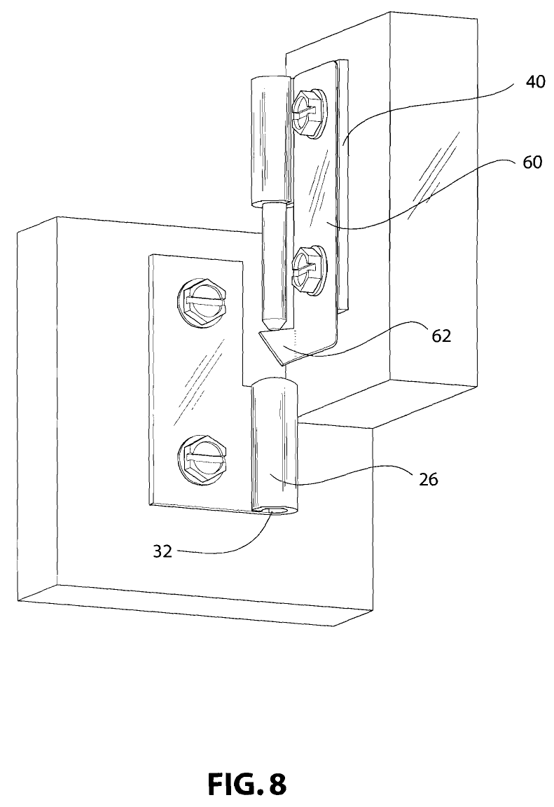

The discussion so far has been directed to an embodiment where the locking tab 62 has been associated with the first hinge part 20. Directing attention to FIG. 8, it is entirely possible for the same support plate 60 to be attached to the second hinge part 40 with the same result. Under these circumstances, the locking tab 62 will engage the bottom 32 of the sleeve 26. Just as before, it is also possible, although not shown, for the tab 62 to be an integral part of the second hinge part 40, thereby eliminating the need for the support plate 60. Using this arrangement, the first hinge part 20 may be secured to the second hinge part 40.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. A lockable connector comprising:
a first hinge part having a sleeve with a bore extending along a longitudinal axis;
a second hinge part having a post support with a post extending therefrom, wherein the post extends along the longitudinal axis and is slidingly positioned within the bore of the sleeve and wherein the sleeve abuts with the post support; and
a resilient locking tab positioned to secure the hinge parts with respect to one another along the longitudinal axis.

2. The lockable connector according to claim 1, wherein the resilient locking tab is either attached to the first hinge part and positioned to overlap with and axially secure the top of the post support or is attached to the second hinge part and positioned to overlap with and axially secure the bottom of the sleeve.

3. The lockable connector according to claim 2, wherein the locking tab is an integral with the respective hinge part.

4. The lockable connector according to claim 2, wherein the locking tab is part of a separate support plate.

5. The lockable connector according to claim 4, wherein the first hinge part and the second hinge part each have mounting apertures for accepting fasteners for mounting the hinge parts to a respective first member and second member.

6. The lockable connector according to claim 5, wherein the support plate has support plate apertures that align with at least two of the first hinge part apertures.

7. The lockable connector according to claim 6, wherein the support plate is positioned over the first hinge part and both are secured to a member using fasteners extending through matching apertures.

8. The lockable connector according to claim 5, wherein the support plate has support plate apertures that align with at least two of the second hinge part apertures.

9. The lockable connector according to claim 8, wherein the support plate is positioned over the second hinge part and both are secured to a member using fasteners extending through matching apertures.

10. The lockable connector according to claim 1, wherein the first hinge part and the second hinge part pivot about the post relative to one another.

11. The lockable connector according to claim 1, wherein the first hinge part and the second hinge part are non-pivotal about the post relative to one another.

12. A locking device for use with a first hinge part having a sleeve with a bore extending along a longitudinal axis and a second hinge part having a post support with a post extending therefrom, wherein the post extends along the longitudinal axis and is slidingly positioned within the bore of the sleeve and wherein the sleeve abuts with the post support, wherein the locking device comprises:
a support plate with a generally planar base and a resilient tab extending from the base in an out-of-plane orientation, wherein the plate is adapted to be positioned such that the tab interferes with the axial motion of the first hinge part relative to the second hinge part to secure the first hinge part to the second hinge part.

13. The lockable connector according to claim 12, the support plate has apertures extending therethrough that align with matching apertures on one of the first hinge part or the second hinge part such that the support plate may be secured to one of the hinge parts using the same fasteners that would be used to secure the hinge part to a member.

14. A furniture piece comprising:
a) a first member generally lying in a first member plane;
b) a second member generally lying in a second member plane;
c) wherein the first hinge part is attached to the first member and the second hinge part is attached to the second member through a lockable connector;
d) wherein the lockable connector comprises:
1) a first hinge part having a sleeve with a bore extending along a longitudinal axis,
2) a second hinge part having a post support with a post extending therefrom along the longitudinal axis, wherein the second hinge is slidingly positioned within the bore of the sleeve and wherein the sleeve abuts with the post support; and
3) a resilient locking tab positioned to secure the hinge parts with respect to one another along the longitudinal axis.

15. The furniture piece according to claim 14, wherein the resilient locking tab is either attached to the first hinge part and positioned to overlap with and axially secure the top of the post support or is attached to the second hinge part and positioned to overlap with and axially secure the bottom of the sleeve.
